(19) United States
(12) Patent Application Publication
(10) Pub. No.: US 2024/0398520 A1
(43) Pub. Date: Dec. 5, 2024

(54) AUTOMATED LASER METROLOGY FOR DENTAL SURGERY

(71) Applicant: Perceptive Technologies, Inc., Boston, MA (US)

(72) Inventors: Christopher John CIRIELLO, Boston, MA (US); Darren KRAEMER, Boston, MA (US)

(21) Appl. No.: 18/676,163

(22) Filed: May 28, 2024

Related U.S. Application Data
(60) Provisional application No. 63/505,387, filed on May 31, 2023.

(51) Int. Cl. A61C 9/00; G06T 7/00; G06T 17/00

(52) U.S. Cl. CPC A61C 9/0073; G06T 7/00; G06T 17/00; G06T 2207/10101; G06T 2207/30036

(57) ABSTRACT

Disclosed herein are robotic controlled systems and methods for tooth resurfacing utilizing a robotic control unit capable of controlling the movement of a tissue removal mechanism an optical beam path configured to scan the surface of a tooth; a mechanism for tissue removal capable of removing tissue during resurfacing, including: a first mechanism for tissue removal; and a second mechanism for stance measurement to the tooth surface using metrology methods; a metrology beam recording system integrated within the optical beam path, configured to record the original and final position of the tooth surface during the tissue removal process, and to generate a ‘difference map’ representing the remaining tissue to be removed; a 3D model of a target tooth shape; and a control algorithm capable of adjusting parameters based on the difference map and the difference in shape between the tooth and the 3D model.

### CROSS-REFERENCE

This application claims the benefit of U.S. Provisional Application No. 63/505,387, filed May 31, 2023, which is incorporated herein by reference in its entirety.

### BACKGROUND

The existing dental treatment apparatuses or systems are unable to achieve automated dental surface imaging/digital impression taking. The existing apparatuses or systems rely on the dentist or auxiliary manually moving the dental scanner (Align technology, ITero, 3Shape, etc) This surface data is used or a variety of workflows including post-surgically for fitting crown prosthetics. Hand-held laser cutters do no create 3d geometry which can be used for an impression substitute while cutting teeth. These approaches require an additional impression or digital impression step which is time-consuming and requires skilled operator time—increasing costs. With automated dental treatment systems under development, there is thus a need to automate dental impression taking to automate dental workflows.

### SUMMARY

In dentistry, various methods are used for 3D imaging of tooth shape. These methods can be categorized into two main types: intraoral and extraoral imaging. Here are some current methods with an emphasis on their speed:

Intraoral Scanners (Fast): Intraoral scanners are handheld devices that capture 3D images of the teeth directly inside the mouth. They use technologies like structured light or laser scanning to create digital impressions of the teeth. Intraoral scanners offer the advantage of being fast and accurate, allowing for real-time visualization of the scanned area. Some popular intraoral scanners include the 3Shape TRIOS, iTero Element, and Carestream CS 3600. [Reference: Mehl, A., & Ender, A. (2018). Full arch scans: conventional versus digital impressions—an in-vitro study. International Journal of Computerized Dentistry, 21(1), 11-21.]

Cone Beam Computed Tomography (CBCT) (Fast): CBCT is an extraoral imaging technique that provides volumetric 3D images of the teeth and jaws. It uses a cone-shaped X-ray beam and a detector to capture a series of 2D images, which are then reconstructed into a 3D representation. CBCT is fast and provides high-resolution images, making it useful for various applications in dentistry, such as implant planning and orthodontic assessment. [Reference: Scarfe, W. C., & Farman, A. G. (2008). What is cone-beam CT and how does it work? Dental Clinics, 52(4), 707-730.]

Digital Dental Radiography (Fast): Digital radiography, including both intraoral and extraoral techniques, can provide 2D images that can be used to assess tooth shape and structure. Digital radiographs offer the advantage of immediate image acquisition and can be easily manipulated for enhancement or measurement. Examples of digital radiographic techniques used in dentistry include digital intraoral sensors and panoramic radiography. [Reference: Tyndall, D. A., & Rathore, S. (2008). Cone-beam CT diagnostic applications: caries, periodontal bone assessment, and endodontic applications. Dental Clinics, 52(4), 825-841.]

Photogrammetry (Fast/Slow): Photogrammetry involves capturing multiple photographs of an object from different angles and then using specialized software to reconstruct a 3D model. In dentistry, photogrammetry can be used to create digital models of the teeth using either a dedicated intraoral camera or standard digital cameras. The speed of photogrammetry can vary depending on the number of photographs needed and the complexity of the software used for reconstruction. [Reference: Zhuang, L., Wei, M., Yu, H., Wu, Q., & Swain, M. V. (2018). 3D digital photogrammetry for quantifying tooth wear. Journal of Dentistry, 70, 83-89.]

Optical Coherence Tomography (OCT) is another method used for 3D imaging of tooth shape in dentistry. OCT is a non-invasive imaging technique that utilizes light waves to create high-resolution cross-sectional images of biological tissues, including teeth. It provides detailed information about the internal structures of the tooth, such as enamel, dentin, and pulp.

OCT has the advantage of being fast and providing real-time imaging, allowing for immediate assessment of tooth morphology. It can assist in detecting early stages of dental caries, evaluating the integrity of restorations, and assessing the condition of the periodontal tissues. Furthermore, OCT can be used in conjunction with other imaging modalities, such as CBCT, to enhance the diagnostic capabilities. (Fried, D., & Glena, R. E. (2012). Optical coherence tomography: a new imaging technology for dentistry. Journal of the American Dental Association, 143(6), 682-691., Shimada, Y., Sadr, A., & Sumi, Y. (2018). Recent advances in nondestructive caries detection technology. Journal of Dental Research, 97(7), 771-778.)

With respect tooth reshaping, there are several methods that can be incorporated into a dental robot for automated procedures including

Dental Handpieces: Dental handpieces are commonly used in dental procedures, including tooth reshaping. They can be adapted for use with dental robots, allowing for automated tooth preparation and reshaping tasks. Dental handpieces utilize rotating burrs or diamond-coated instruments to precisely remove and shape tooth structure.

Laser Dentistry: Dental lasers have gained popularity in various dental procedures, including tooth reshaping. Laser technology allows for precise and controlled removal of tooth structure. Incorporating laser technology into a dental robot can enable automated reshaping procedures with reduced invasiveness and enhanced precision.

Ultrasonic Instruments: Ultrasonic instruments are commonly used in dental procedures for various purposes, including tooth reshaping. These instruments use ultrasonic vibrations to remove tooth structure efficiently and with minimal damage to surrounding tissues. Integrating ultrasonic instruments into a dental robot can facilitate automated tooth reshaping procedures.

Previously, systems have been proposed for automated laser dental re-shaping, which include imaging such as Patent No.: U.S. Pat. No. 11,337,773B2. However, this disclosure does not teach the method of reducing mechanical tolerances through feedback control using imaging or laser metrology, to achieve determine the optimal laser parameters during the tissue reshaping.

The present disclosure relates to a robotic dental device capable of machining the shape of teeth based on 3D imaging, incorporating real-time or iterative imaging to improve the accuracy and reduce the tolerances of the final tooth shape. Dental treatments often require precise shaping and modification of teeth, necessitating the use of advanced technology to ensure accurate and efficient procedures. The inventive robotic dental device utilizes mechanical or laser machining with real-time or iterative 3d imaging to enable precise machining of teeth, providing improved outcomes for patients and dental professionals.

The robotic dental device described herein integrates mechanical or laser machining technology and real-time or iterative 3d imaging capabilities to facilitate the accurate machining of teeth. The device comprises a robotic arm or a similar mechanical structure equipped with machining tools, sensors, and a control system. The 3D imaging system captures high-resolution images of the teeth, providing a detailed and accurate representation of their shape and structure. The real-time or iterative imaging system further enhances the precision by continuously or iteratively updating the imaging data during the machining process, allowing for dynamic adjustments and guidance. In some embodiments the same laser is used for the 3d imaging and the tooth reshaping.

The control system of the robotic dental device processes the 3D imaging data and real-time or iterative imaging information to generate precise instructions for the robotic arm. These instructions guide the machining tools to remove specific areas of the tooth structure, reshape the teeth, and perform other dental procedures based on predetermined shapes which are the preferred outcome of the reshaping process. The robotic arm, with its articulated joints and precision mechanisms, carries out the machining process with exceptional accuracy and consistency, minimizing human error and ensuring optimal outcomes.

Real-time imaging can play a crucial role in reducing tolerances of final machined parts, especially when applied to reshaping human teeth that exhibit varying degrees of tissue density and mechanical properties. By incorporating real-time imaging into the robotic dental device, the following benefits can be achieved:

Accurate Visualization: Real-time imaging techniques, such as intraoral cameras or optical coherence tomography (OCT), provide live visual feedback during the machining process. This allows dental professionals to observe the tooth reshaping procedure in real-time, ensuring precise control and adjustment.

Dynamic Tissue Analysis: Teeth exhibit variations in tissue density and mechanical properties, such as enamel, dentin, and pulp. Real-time imaging enables continuous analysis of these properties, allowing the robotic dental device to adapt its machining parameters accordingly. By monitoring tissue response during the process, adjustments can be made to optimize the machining strategy and minimize material removal while achieving the desired shape.

Iterative Modifications: Real-time imaging allows for iterative adjustments during the machining process. Dental professionals can closely monitor the progress, evaluate the shape and aesthetics of the reshaped tooth, and make necessary modifications in real-time. This iterative approach ensures precise control over the final result, reducing tolerances and enhancing the overall outcome.

Measurement and Feedback: Real-time imaging can be used to measure critical dimensions and provide feedback to the control system. By continuously assessing the machined tooth's dimensions, the system can automatically make adjustments to ensure the desired tolerances are met. This feedback loop ensures that any deviations from the intended shape are promptly detected and corrected, improving the accuracy of the machining process.

Patient-Specific Adaptation: Human teeth vary in shape, size, and individual characteristics. Real-time imaging allows the robotic dental device to adapt its machining strategy to each patient's unique dental structure. By continuously monitoring and analyzing real-time imaging data, the device can account for specific variations in tissue density and mechanical properties, resulting in highly customized and precise reshaping of teeth.

A robotically controlled imaging system offers several advantages over a handheld imaging system when it comes to high accuracy guidance of the robotic machining process. Here are some key advantages:

Consistency and Stability: A robotically controlled imaging system is firmly integrated with the robotic arm or mechanical structure. This integration ensures consistent positioning and stability of the imaging system during the entire machining process. In contrast, a handheld imaging system relies on the operator's hand movements, which may introduce slight variations in positioning and stability. The consistency and stability provided by a robotically controlled imaging system contribute to higher accuracy in guiding the robotic machining process.

Precise Alignment: The imaging system needs to align accurately with the dental structure for precise guidance. A robotically controlled imaging system can be programmed to achieve precise alignment with the tooth or the area of interest. The robotic arm's articulated joints and precise positioning mechanisms enable accurate alignment, reducing the risk of misalignment or distortion in the imaging data. In contrast, a handheld imaging system relies on the operator's skill to align the device, which may be more prone to human error and misalignment.

Automation and Integration: A robotically controlled imaging system can be seamlessly integrated into the overall robotic dental device, allowing for automation and smooth workflow. The imaging system can communicate directly with the control system of the robotic arm, enabling real-time data exchange and synchronization. This integration streamlines the process, eliminates manual steps, and reduces the chances of errors or delays associated with transferring data between separate handheld devices and the robotic arm.

Enhanced Imaging Stability: Handheld imaging systems may be subject to slight movements or vibrations caused by the operator's hand, resulting in imaging artifacts or blurriness. In contrast, a robotically controlled imaging system can be designed with mechanisms to minimize or eliminate vibrations and movements, ensuring stable imaging throughout the machining process. The enhanced imaging stability contributes to improved accuracy and reliability in guiding the robotic machining process.

Reproducibility: With a robotically controlled imaging system, the imaging process can be precisely replicated for subsequent procedures. The imaging system's position and parameters can be programmed and saved, allowing for consistent imaging and guidance in future machining processes. This reproducibility reduces the variability between procedures and improves the overall accuracy and reliability of the robotic machining system.

Aspects provided herein include a robotic controlled system for tooth resurfacing, comprising: a robotic control unit capable of controlling the movement of a tissue removal mechanism; an optical beam path configured to scan the surface of a tooth; a mechanism for tissue removal capable of removing tissue during resurfacing, including: a first mechanism for tissue removal; and a second mechanism for stance measurement to the tooth surface using metrology methods; a metrology beam recording system integrated within the optical beam path, configured to record the original and final position of the tooth surface during the tissue removal process, and to generate a ‘difference map’ representing the remaining tissue to be removed; a 3D model of a target tooth shape; a control algorithm capable of adjusting parameters based on the difference map and the difference in shape between the tooth and the 3D model, wherein the parameters include at least one of speed, force, and duration of the tissue removal mechanism; and g. a feedback mechanism to achieve minimal deviation from the target shape during tooth resurfacing. In some embodiments, a mechanism of removal of dental tissue is a laser having sufficient intensity to ablate dental tissue. In some embodiments, a mechanism of removal of dental tissue is a short, pulsed laser. In some embodiments, a means of 3d imaging is Optical coherence tomography. In some embodiments, an imaging information is used to redefine the desired outcome based upon tissue characteristics which are uncovered by the imaging during the tissue reshaping process.

Aspects provided herein include a robotic controlled optical beam path system for tooth resurfacing, comprising: a robotic control unit capable of controlling the movement of a laser beam delivery system; an optical beam path configured to scan the surface of a tooth; a laser source capable of transmitting two separate beams, including: a first beam for laser ablation of tissue during resurfacing; and a second beam for distance measurement to the tooth surface using metrology methods; a metrology beam recording system integrated within the optical beam path, configured to record the original and final position of the tooth surface during pulse bursts of the ablation beam, and to generate a ‘difference map’ representing the remaining tissue to be removed; a 3D model of a target tooth shape; a control algorithm capable of adjusting laser parameters based on the difference map and the difference in shape between the tooth and the 3D model, wherein the laser parameters include at least one of repetition rate, pulse energy, pulse duration, and repetition rate; and a feedback mechanism to achieve minimal deviation from the target shape during tooth resurfacing. In some embodiments, the profilometry is based on a laser technique that utilizes the same laser for profilometry and ablation. In some embodiments, the rate of change of the difference map is used to adjust the laser parameters to optimize the material removal rate. In some embodiments, the metrology beam recording system further comprises an acoustic signature detection module, wherein the ablation laser generates an acoustic signature detected by a high-frequency microphone within the housing of the beam delivery assembly, and the distance of the tooth surface exposed to the ablating laser beam from the microphone is determined based on the time difference between the impact of the optical pulse and the arrival of the sound from the acoustic signature, enabling the creation of a tooth surface map and wherein the control algorithm adjusts the laser parameters based on the tooth surface map obtained from the metrology beam recording system, facilitating precise laser ablation to converge on the desired target tooth shape. In some embodiments, the laser scanning is accomplished using a MEMS mirror. In some embodiments, the feedback mechanism comprises a continuous monitoring of the difference map and the tooth surface map, facilitating dynamic adjustments to the laser parameters to achieve optimal tooth resurfacing results.

Aspects provided herein include a method of performing an automated dental procedure comprising: receiving a 3D model of a tooth comprising an initial tooth shape, and a target tooth shape; directing a first laser beam to a surface of the tooth, the first laser beam measuring a distance from the tooth using a metrology beam recording system integrated within an optical beam path of the first laser beam; directing a second laser beam to the surface of the tooth, the second laser beam ablating a portion of the tooth; recording an initial position and a final position of the tooth surface following the ablating the portion of the tooth, and generating a difference map representing an amount of tissue of the tooth which was removed by the ablating the portion of the tooth relative to the 3D model of the tooth; and adjusting at least one laser parameter based upon the difference map to ablate a second portion of the tooth to achieve a minimal deviation from the target tooth shape and the difference map, wherein the laser parameters comprise comprising repetition rate, pulse energy, pulse duration, or repetition rate. In some embodiments, the second laser beam comprises sufficient intensity to ablate dental tissue. In some embodiments, the second laser beam is generated using a pulsed laser. In some embodiments, the first laser beam is comprised by an OCT system, wherein the OCT system generates the difference map. In some embodiments, the difference map is used to redefine a desired outcome based upon tissue characteristics of the tooth which are uncovered by the generating the difference map. In some embodiments, the first laser beam and the second laser beam are generated using a same light source. In some embodiments, a rate of change of the difference map is used to adjust the laser parameters to optimize the ablating the portion of the tooth. In some embodiments, the directing the first laser beam or the directing the second laser beam is directed using a Micro-electromechanical system (MEMS) mirroring some embodiments, the method further includes generating a tooth surface map with the first laser beam. In some embodiments, the method further includes receiving feedback on the status of the procedure by continuous monitoring of the difference map and the tooth surface map and performing dynamic adjustments to the laser parameters to achieve to achieve a minimal deviation from the target tooth shape and the tooth surface map.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows an exemplary flow chart of a system for automated laser metrology for dental surgery, per an embodiment herein.

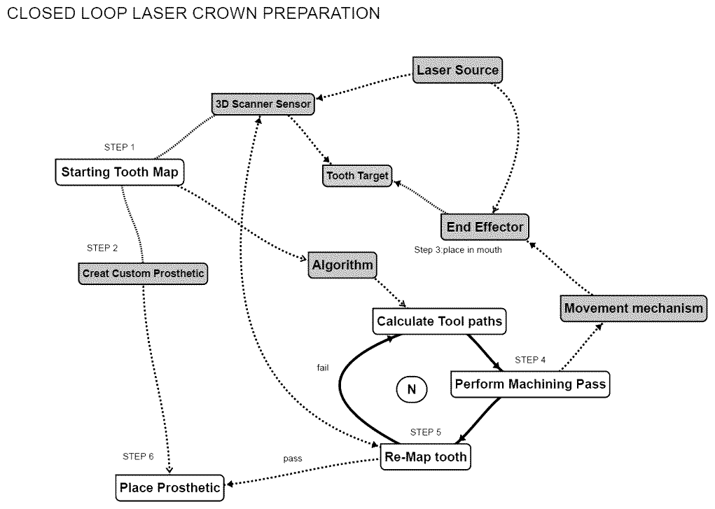

### DETAILED DESCRIPTION

In some embodiments, the present disclosure herein includes a robotically controlled laser beam which is run over the tooth in a set pattern so to fully capture 3d tooth geometry at the surgical site. This laser may be also used to cut the tooth, or used only to scan the surface of the tooth while a mechanical cutter subsequently cuts the tooth. Unlike existing systems, this process if fully automated as the beam is directed over the tooth surface by a robotically controlled positioning system. This system may be guided by a preexisting 3d surface geometry or may be generated by the system within a set volume. This data may be informed by subsurface tooth anatomical data (radiographs, CT scans, OCT scans), or from data that can be both extrapolated from an existing data set to guide the rough scanning area, or by parameters set by the clinician, or by registering patient-specific radiographic and ultrasonic generated subsurface imaging.

In general the device includes the following.

### Robotic Arm and Machining Tools:

The robotic dental device incorporates a robotic arm or a similar mechanical structure capable of movement and precision positioning.

The arm comprises multiple articulated joints that enable precise control over the machining tool and imaging devices positioning and orientation.

The machining tools include but are not limited to dental drills, milling cutters, lasers optimized for tooth ablation or any other appropriate cutting instruments used in dental procedures.

### 3D Imaging System:

The device is equipped with a high-resolution 3D imaging system capable of capturing detailed images of the teeth and surrounding oral structures.

The imaging system may utilize technologies such as cone-beam computed tomography (CBCT), structured light scanning, laser scanning, optical coherence tomography (OCT) or any other suitable 3D imaging techniques.

The resulting 3D images provide a comprehensive representation of the teeth, enabling accurate visualization and analysis.

### Real-Time or Iterative Imaging System:

The device incorporates a real-time or iterative imaging system which is fast enough to continuously or iteratively update the imaging data during the machining process.

This system may utilize intraoral cameras, optical coherence tomography (OCT), or any other suitable imaging techniques.

The real-time or iterative imaging system provides up-to-date information on the tooth structure, ensuring precision during the machining process.

### Control System:

The robotic dental device features a control system comprising hardware and software components.

The control system processes the 3D imaging data and real-time or iterative imaging information to generate precise instructions for the robotic arm.

The instructions account for the desired tooth shape which is predetermined before the procedure begins, the areas to be removed or modified, and other parameters defined by the dental professional.

The control system ensures synchronization between the imaging systems, the robotic arm, and the machining tools.

The robotic dental device described herein offers several advantages over traditional dental machining methods:

Enhanced Precision: The integration of 3D imaging technology and real-time or iterative imaging ensures exceptional precision during tooth machining, leading to improved dental outcomes.

Efficiency and Consistency: The robotic arm performs the imaging and the machining process consistently and accurately, reducing human error and providing consistent results.

Customization and Iterative Adjustments: The real-time or iterative imaging system allows for dynamic adjustments during the machining process, enabling iterative modifications to achieve optimal tooth shape and structure.

Time Savings: The robotic dental device streamlines the machining process, potentially reducing treatment time and improving overall dental clinic efficiency.

In some embodiments, the laser creates a surface density map. this system is a laser equivalent to mechanical based torque-sensing inferring the density of the tooth being cut, effectively enabling variable density laser ablation, or better-informing clinician decision making.

In some embodiments, the laser will be used to profile the material being cut into sound or decayed enamel, sound or decayed dentin, sound or decayed cementum, amalgam, or other existing restorative material.

In some embodiments, the laser will be used in automated devices executing closed-loop surgical tool paths that may be dynamically extended to include decayed tooth structure while avoiding other important clinical landmarks (the pulp). Specifically, some tooth material will need to be removed (decayed tooth, caries), while other tooth structure under the beam needs to remain intact (healthy tooth).

In some embodiments, the metrology feature to profile the surface being cut is used to create a 3d surface scan, or digital impression that can be used in place of intraoral scans pre surgically (for Invisalign) or post-surgically for crown prosthetic fabrication.

In some embodiments, the surface is determined via an interferometric effect. In some embodiments, this is determined via a photoacoustic effect.

In one embodiment, the sane robotically controlled optical beam path, which is capable of scanning the surface of the tooth, transmits two separate beams: one for laser ablation of the tissue for resurfacing, and another for distance measurement to the tooth surface, such as OCT or other laser metrology methods. During or interwoven within pulse bursts of the ablation beam, the metrology beam records the original and final position of the tooth surface in order to acquire a ‘difference map’ that corresponds to the amount of tissue that still needs to be removed. As the difference in shape between the tooth and the 3D model of the target shape decreases, the laser parameters, such as repetition rate and pulse energy, are reduced to converge on the final shape with minimal tolerance.

Furthermore, the rate of change of the difference, map provides a measurement of the spatially relevant rate of tissue removal, fromm which the ablation laser parameters, such as pulse duration and repetition rate, can be adjusted to achieve optimal removal rates with minimal heat increase or other deleterious over exposure.

In another embodiment, the imaging can reveal characteristics of the tissue such as tooth decay or other conditions which are subsequently used to redefine the target tissue shape during the tissue reshaping process. In this way, the feedback loop not only alters the tool path, but also the outcome to provide optimized treatment of dental conditions.

In another embodiment, MEM's mirrors are used as a means of directing the beam within the robotically controlled optical beam path.

In another embodiment, an acoustic signature produced by the ablation laser is detected by a high-frequency (audible to ultrasound) microphone located within the housing of the beam delivery assembly. This microphone enables determination of the distance between the tooth surface exposed to the ablating laser beam and the microphone by calculating the time difference between the impact of the optical pulse and the arrival of the sound generated by the acoustic signature of the laser ablation. The delayed signal's leading edge corresponds to the distance traveled by the sound waves, as the sound arrives later due to the limited speed of sound. By employing adequate electronic resolution, the time delay is measured, and a map of the tooth surface is created as the optics are robotically scanned across the relevant surfaces of the tooth.

Utilizing this measurement mechanism, laser ablation can be controlled by using the difference map to guide the laser ablation process and achieve convergence with the desired target tooth shape.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%, 50%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

What is claimed is:

1. A robotic controlled system for tooth resurfacing, comprising:
a) a robotic control unit configured to control the movement of a tissue removal mechanism;
b) an optical beam path configured to scan the surface of a tooth;
c) a mechanism for tissue removal configured to remove tissue during resurfacing, comprising:
i) a first mechanism configured to perform tissue removal, and
ii) a second mechanism configured to perform stance measurement to the tooth surface using metrology methods;
d) a metrology beam recording system integrated within the optical beam path, configured to record the original and final position of the tooth surface during the tissue removal process, and to generate a ‘difference map’ representing the remaining tissue to be removed;
e) a 3D model of a target tooth shape;
f) a control algorithm configured to adjust parameters based on the difference map and the difference in shape between the tooth and the 3D model, wherein the parameters include at least one of speed, force, and duration of the tissue removal mechanism; and
g) a feedback mechanism configured to achieve minimal deviation from the target shape during tooth resurfacing.

2. The system of claim 1, wherein the mechanism for removal of dental tissue is a laser having sufficient intensity to ablate dental tissue.

3. The system of claim 1, wherein the mechanism for removal of dental tissue is a short pulsed laser.

4. The system of claim 1, wherein the means of 3d imaging is Optical Coherence Tomography (OCT).

5. The system of claim 1, wherein the imaging information is used to redefine the desired outcome based upon tissue characteristics which are uncovered by the imaging during the tissue reshaping process.

6. A robotic controlled optical beam path system for tooth resurfacing, comprising:
a) a robotic control unit capable of controlling the movement of a laser beam delivery system;
b) an optical beam path configured to scan the surface of a tooth;
c) a laser source capable of transmitting two separate beams, including:
i. a first beam configured to perform laser ablation of tissue during resurfacing, and
ii. a second beam configured to perform distance measurement to the tooth surface using metrology methods;
d) a metrology beam recording system integrated within the optical beam path, configured to record the original and final position of the tooth surface during pulse bursts of the ablation beam, and to generate a ‘difference map’ representing the remaining tissue to be removed;
e) a 3D model of a target tooth shape;
f) a control algorithm configured to adjust laser parameters based on the difference map and the difference in shape between the tooth and the 3D model, wherein the laser parameters include at least one of repetition rate, pulse energy, pulse duration, and repetition rate; and
g) a feedback mechanism to achieve minimal deviation from the target shape during tooth resurfacing.

7. The system of claim 6, wherein the rate of change of the difference map is used to adjust the laser parameters to optimize the material removal rate.

8. The system of claim 6, wherein the metrology beam recording system further comprises an acoustic signature detection module, wherein the ablation laser generates an acoustic signature detected by a high-frequency microphone within the housing of the beam delivery assembly, and the distance of the tooth surface exposed to the ablating laser beam from the microphone is determined based on the time difference between the impact of the optical pulse and the arrival of the sound from the acoustic signature, enabling the creation of a tooth surface map and wherein the control algorithm adjusts the laser parameters based on the tooth surface map obtained from the metrology beam recording system, facilitating precise laser ablation to converge on the desired target tooth shape.

9. The system of claim 6, wherein the laser scanning is accomplished using a MEMs mirror.

10. The system of claim 6, wherein the feedback mechanism comprises a continuous monitoring of the difference map and the tooth surface map, facilitating dynamic adjustments to the laser parameters to achieve optimal tooth resurfacing results.

11. A method of performing an automated dental procedure comprising:
a) receiving a 3D model of a tooth comprising an initial tooth shape, and a target tooth shape;
b) directing a first laser beam to a surface of the tooth, the first laser beam measuring a distance from the tooth using a metrology beam recording system integrated within an optical beam path of the first laser beam;
c) directing a second laser beam to the surface of the tooth, the second laser beam ablating a portion of the tooth;
d) recording an initial position and a final position of the tooth surface following the ablating the portion of the tooth, and generating a difference map representing an amount of tissue of the tooth which was removed by the ablating the portion of the tooth relative to the 3D model of the tooth; and
e) adjusting at least one laser parameter based upon the difference map to ablate a second portion of the tooth to achieve a minimal deviation from the target tooth shape and the difference map, wherein the laser parameters comprise comprising repetition rate, pulse energy, pulse duration, or repetition rate.

12. The method of claim 11, wherein the second laser beam comprises sufficient intensity to ablate dental tissue.

13. The method of claim 11, wherein the second laser beam is generated using a pulsed laser.

14. The method of claim 11, wherein the first laser beam is comprised by an OCT system, wherein the OCT system generates the difference map.

15. The method of claim 11, wherein the difference map is used to redefine a desired outcome based upon tissue characteristics of the tooth which are uncovered by the generating the difference map.

16. The method of claim 11, wherein the first laser beam and the second laser beam are generated using a same light source.

17. The method of claim 11, wherein a rate of change of the difference map is used to adjust the laser parameters to optimize the ablating the portion of the tooth.

18. The method of claim 11, wherein the directing the first laser beam or the directing the second laser beam is directed using a Micro-electromechanical systems (MEMS) mirror.

19. The method of claim 11, further comprising generating a tooth surface map with the first laser beam.

20. The method of claim 11, further comprising receiving feedback on the status of the procedure by continuous monitoring of the difference map and the tooth surface map and performing dynamic adjustments to the laser parameters to achieve to achieve a minimal deviation from the target tooth shape and the tooth surface map.
